(19) United States
(12) Patent Application Publication
(10) Pub. No.: US 2025/0094428 A1
(43) Pub. Date: Mar. 20, 2025

(54) OBJECT GOVERNANCE CONTROLS IN MULTI-TENANT NoSQL DATASTORE

(71) Applicant: VMware, Inc., Palo Alto, CA (US)

(72) Inventors: Sanjiev Chattopadhya, Vienna, VA (US); Kiran K. Pothapragada Venkata, Fairfax, VA (US)

(21) Appl. No.: 18/369,769

(22) Filed: Sep. 18, 2023

(51) Int. Cl. G06F 16/2457; G06F 16/2455

(52) U.S. Cl. CPC G06F 16/2457; G06F 16/2455

(57) ABSTRACT

The disclosure provides a techniques for implementing custom tenant governance controls for objects stored in a datastore. A method includes receiving a request from a tenant for enrollment in a governance service with a service provider; creating a tenant control catalog with an object governor registry based on the request for enrollment; receiving, from the tenant, a specification for object governors, wherein the specification comprises at least a name, a condition indicating when to implement one of the object governors, and code of a policy handler that is executed when the one of the object governors is implemented based on satisfaction of the condition; creating the object governors within the object governor registry based on the specification; and causing the code of the policy handler to be executed when the condition of at least one of the object governors is satisfied.

### BACKGROUND

Datastore-as-a-Service (DaaS) (e.g., database-as-a-service (DBaaS)) is a cloud and/or on-premise computing service that lets users access and use a cloud datastore system without requiring their own hardware and datastore software. The cloud provider takes care of maintaining and operating the datastore which includes, for example, upgrades, backups, and the like to ensure that the datastore system remains available and secure. The market for DaaS and cloud datastores is a fast growing aspect of Software-as-a-Service (SaaS) markets. Datastore vendors offer their hosting services in an on-premise environment, hosted environment, cloud environment, a hybrid cloud environment (e.g., utilizing a combination of cloud and on-premise resources) or in combinations thereof.

Datastore hosting options are available for all database types, including NoSQL and SQL based offerings, such as MySQL and PostgreSQL. A DaaS subscription includes everything required to operate a datastore in the cloud, a hybrid environment or an on-premise environment, including datastore provisioning, licenses, support, and maintenance. Developers can make use of cloud (or hybrid or on-premise) hosted APIs to build out new applications, as well as access and manipulate data programmatically. Because of this, DaaS shares many similarities with other SaaS subscription-based cloud offerings.

However, multi-tenant NoSQL datastore Software-as-a-Service (SaaS) providers face unique challenges in implementing data governance controls that are specific to each tenant. They must overcome numerous challenges in segregating tenant data and implementing tenant level specific controls for data governance. These challenges exist in cloud-based, hybrid-based, and on-premise-based service offerings.

### SUMMARY

One or more embodiments provide a method for implementing custom tenant governance controls for objects stored in a datastore. The method includes receiving a request from a tenant for enrollment in a governance service with a service provider; creating a tenant control catalog with an object governor registry based on the request for enrollment; receiving, from the tenant, a specification for one or more object governors, wherein the specification comprises at least a name, a condition indicating when to implement one of the one or more object governors, and code of a policy handler that is executed when the one of the one or more object governors is implemented based on satisfaction of the condition; creating the one or more object governors within the object governor registry based on the specification; and causing the code of the policy handler to be executed when the condition of at least one of the one or more object governors is satisfied.

Further embodiments include one or more non-transitory computer-readable storage media comprising instructions, which when executed by one or more processors of a computer system, cause the computer system to carry out the above methods, as well as a computer system comprising one or more memories and one or more processors configured to carry out the above methods.

### BRIEF DESCRIPTION OF THE DRAWINGS

FIG. 1 illustrates an example of multiple tenants using a shared Datastore-as-a-Service (DaaS) system, in accordance with some embodiments.

FIG. 2 illustrates an example multi-tenant DaaS, in accordance with some embodiments.

FIG. 3 illustrates an example of multiple tenants using a single shared Datastore-as-a-Service (DaaS) system including implementation of a governance service provider, in accordance with some embodiments.

FIG. 4 illustrates aspects of a governance data structure for governance service operations, in accordance with some embodiments.

FIG. 5 illustrates example operations for enrolling in a governance service operations, in accordance with some embodiments.

FIG. 6 illustrates example process flow for performing governance service operations, in accordance with some embodiments.

FIG. 7 illustrates example process flows for application specific operations with the governance service, in accordance with some embodiments.

FIG. 8 illustrates example operations for unenrolling from a governance service, in accordance with some embodiments.

FIG. 9 depicts an example processing system configured to perform governance service methods, in accordance with some embodiments.

### DETAILED DESCRIPTION

Embodiments of the present disclosure provide techniques for improving data governance and cybersecurity for datastores, such as datastores for regulated and non-regulated industries such as banking, finance, education, and others. NoSQL Datastore-as-a-Service (DaaS) providers offer a managed service which allows tenants to use a datastore service without having to build and manage their own infrastructure. While the techniques described herein are applicable in numerous scenarios, such as other datastores, they will be primarily described with application to multi-tenant NoSQL DaaS providers who offer their service in a single realm (e.g., a single object database management system) where the service runs within one context using the same user identifier. As used herein, a “realm” refers to a combination of software, hardware and supporting components (such as storage, file folders, metadata, configurations, etc.), for a single service offering from a DaaS.

A datastore, as used herein, refers to a system for storing data persistently. Examples of a datastore include organized data storage systems such as databases, data warehouses, data lakes, file systems, object storage systems, and any combination thereof. A datastore includes a persistent data storage where, in certain aspects, data is stored (e.g., by applications) as unstructured or semi-structured data. In certain aspects, the data can be accessed without having to use the Structured Query Language (SQL) which is also called NoSQL. A database is a particular type of datastore where data is stored in files on a file storage system and the files are managed by a database management system. A datastore-as-a-service (DaaS) may refer to a datastore provided as a service and backed by cloud and/or on-premises resources. An example of DaaS is a database-as-a-service (DBaaS).

The techniques are also fully applicable to single tenant environments. For example, single tenant environments with multiple applications can use the techniques to implement supplementary governance controls specific to an application.

Multi-tenant NoSQL DaaS providers face numerous unique challenges in segregating tenant data and implementing tenant level specific controls for data governance within a management plane of the datastore service. When deploying cloud-native applications, this management plane enforces common standards, access controls, and policies across distributed environments. The management plane abstracts the complexity of some control plane operations and provides visibility and insight into the application performance. Due to their lack of visibility and gaps in governance, distributed environments expand the threat surface and increase the likelihood of service disruptions. Furthermore, enforcement of common standards, access controls, and policies do not offer fine grained security controls for individual data items or objects. Implementing such fine-grained security controls in specialized custom technology stacks is expensive for traditional DaaS providers.

However, the techniques described herein provide an extension to general use cases for policies and governance and offers solutions for regulatory and security compliance related areas that have specialized needs pertaining to fine-grained access controls, audit logging, encryption, protection of sensitive data, block chain, artificial intelligence, federated data sharing and/or others. For example, the techniques described herein can be used to implement Row Level Security (RLS) in NoSQL datastores.

As described in detail herein, the techniques provide methods for implementing object governance controls in multi-tenant NoSQL datastores. As used herein, “object” refers to a form of data stored in the datastore. For example, this may include a document, a table, a multimedia file, a sequence, an index, a region of storage that contains a value or group of values, or the like. Object governance refers to the organizational policies, procedures, and technical controls for managing data. Examples of data governance policies include “All credit card numbers shall be encrypted” or “All Social Security Numbers shall be masked”.

In addition to providing readily customizable solutions for regulatory and security compliance that are easy to implement for diverse tenant needs, there is also a need to provide a solution that can be implemented for on-premise DaaS. That is, a feature of implementing data governance includes, in at least some instances, examining data to determine treatment of the data before providing access and/or returning to a user. However, for some tenants it is not desirable to have a third party such as a DaaS provider implementing processes that examine sensitive data. Therefore, there is a need to provide solutions that can run on a tenant's on-premises data center.

For example, US Federal Civilian (FedCiv) Agencies and the US Department of Defense (DoD) have very stringent regulatory requirements for governance of data, as conveyed through the FedRAMP law, Federal Information Processing Standards (FIPS), and other regulations. Implementing these requirements in specialized custom technology stacks is expensive for companies such as DaaS providers. For example, some government entities mandate that all their data must be encrypted and the DoD IL-6 requirements state that cloud service providers allow the DoD to provide (and control) keys used for encryption. While these can be implemented at a tenant specific level, this is a custom solution that is expensive to implement for many different tenants within a multi-tenant DaaS system. Consequently, a technical problem to be solved is how to provide a multi-tenant cloud-based (or hybrid-based or on-premise-based) datastore service which can leverage economies of scale and conform to applicable computing principles for cloud, hybrid, and on-premise environments, while being flexible and extensible to allow customers to implement their own data governance policies.

As described herein, the implementation of new data structures referred to as an Object Governor, Object Governor Registries, and Master Tenant Registry provide a tenant the ability to implement tenant level governance policies without having to implement custom logic at an application level or a DaaS provider having to generate highly customized policies for unique tenant requirements.

For example, an existing tenant policy requires that all Social Security Numbers (SSNs) stored in the datastore must be masked, for example, XXX-XX-1234 and now requires that the policy be updated such that all these numbers must now be encrypted. Using traditional approaches, a policy for data masking would be implemented and enforced at the application logic. All applications that perform Create, Read, Update and Delete (CRUD) operations on SSNs would then have to be updated tested and deployed, consequently requiring significant time and high cost to implement. However, using the techniques described herein, a tenant would have an Object Governor that would point to a tenant provided Policy Handler that would automatically mask the SSNs and when the policy is changed to mandate encryption of SSNs, the Policy Handler code that masks the data, would be replaced by one that would encrypt the data. This would be a single change in one place without any code changes at the application tier.

In certain aspects, the order of execution of operations discussed herein in the Policy Handler adhere to BASE (Basically Available, Soft State, Eventually Consistent) properties. For example, it is possible code executing, including of the Policy Handler, may create conflicts and inconsistencies in database records, however, based on the BASE properties, including Eventually Consistent, these conflicts and/or inconsistencies may be irrelevant.

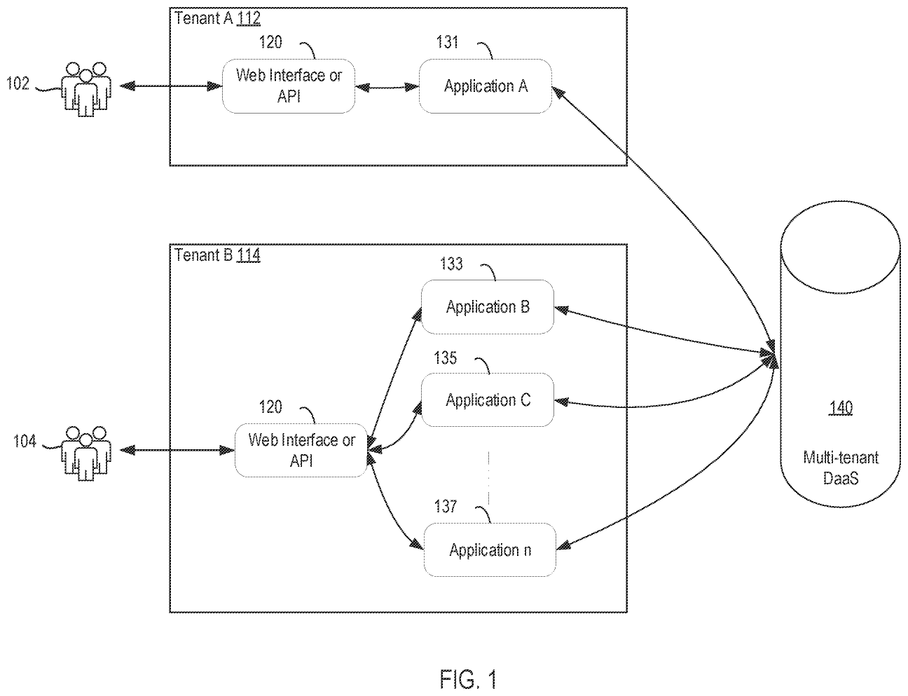

FIG. 1 illustrates multiple tenants using a shared Datastore-as-a-Service (DaaS) system. A first set of users 102 of tenant A 112, optionally through a web interface or application programing interface (API), (collectively referred to as an interface 120 herein), can interface with an application 131 which interacts with objects stored in a multi-tenant DaaS 140. Similarly, a second set of users 104 of tenant B 114, optionally through an interface 120, can interface with one or more applications 133-137, each of which interacts with objects stored in multi-tenant DaaS 140.

The interface 120 may be an intranet or internet connecting users 102 and 104 to applications 131-137. The applications 131-137 may be SaaS based applications or applications hosted and/or operated by a tenant (e.g., tenants 112 and 114).

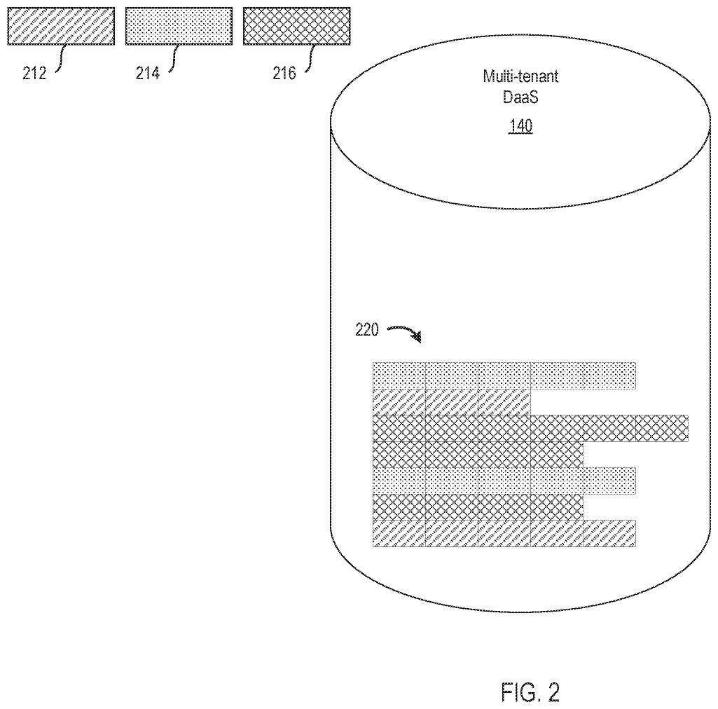

Environments, such as the NoSQL DaaS environment depicted in FIG. 1, have multiple tenants and run within one realm. The issue that arises in such environments is managing the governance of the data for each tenant and application. These datastores currently do not provide built in capabilities for tenants to manage their own data when it is comingled or collocated with the data belonging to multiple tenants. For example, the data belonging to multiple tenants is stored in a single table where Objects belonging to the multiple tenants are stored as rows. For example, FIG. 2 provides an illustrative example of a multi-tenant DaaS 140. Data objects for three separate tenants are shown, including data objects 212 for a first tenant, data objects 214 for a second tenant, and data objects 216 for a third tenant. The data objects 212-216 are stored in separate rows of a single table 220. The multi-tenant DaaS 140 is an example of a NoSQL datastore. NoSQL datastores store data, more commonly referred to as Objects, in a different manner than Relational Database Management Systems (RDBMS) which use tables consisting of structured schemas consisting of columns and rows. In contrast, NoSQL Objects are usually stored without a formal or fixed schema. Instead, NoSQL Objects use a data model. There are four kinds of NoSQL datastores: Key-Value Pairs, Wide Column, Documents, and Graph databases.

Traditionally, the issue of managing the governance of the data for each tenant and application is solved using either a Pooled or Siloed approach.

In a Siloed approach, tenants are segregated by using separate tablespaces or other physical separation methods. However, implementing and managing these tenant specific Siloes reduces efficiencies and increased costs because the database service provider cannot maximize gains by using low cost bulk block storage. Consequently, this approach is not practical for NoSQL DaaS providers who offer their service to multiple tenants using a single instance as illustrated in FIGS. 1 and 2.

For environments with Pooled data running in a single realm, segregating data between multiple tenants in the same datastore is often implemented by embedding tenant or application specific identifiers into the Objects themselves. That is, the identifiers are part of the Object item. However, this means that each tenant or application must implement additional application logic and coding to govern the segregation between tenants and applications within that realm. For the providers of NoSQL DaaS this is a further issue because identifying tenant specific information requires inspecting the tenant's data elements stored in the Objects. However, it may be preferable that DaaS providers not view or modify tenant data. Moreover, the DaaS provider would need to implement additional governance controls to address tenant specific functions such as for billing, logging, security, or other governance purposes within that realm which increases their costs.

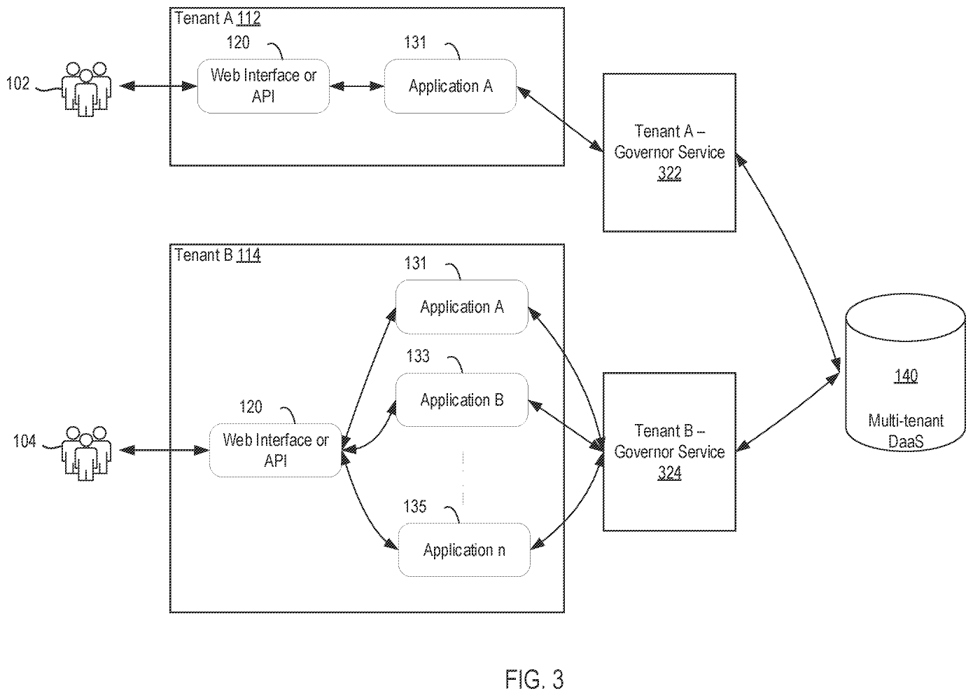

FIG. 3 illustrates an example of multiple tenants using a single shared Datastore-as-a-Service (DaaS) system including implementation of governor services. The implementation of governor services 322 and 324 provides tenants with the capability to implement tenant level governance policies through an Object Governor, Object Governor Registries, and a Master Tenant Registry. For example, the governor service 322 and 324 may reside within a tenant's computing system and therefore address issues with third party providers viewing or modifying tenant's data. Additionally, the governor service 322 and 324 introduce data structures that are customizable by and for each tenant to create, manage, and implement customized policies.

For example, as depicted in FIG. 3, a user 102 or 104 may interface with one or more applications 131-135 that execute one or more CRUD operations on a tenant's Objects stored by a multi-tenant DaaS 140. Before, during, or after the one or more CRUD operations performed on a tenant's Object, the tenant's governor service 322 or 324 determine whether any specific policies should be performed. The policies are defined by the Object Governor and customizable by the tenant. For example, a policy may require that any Object returned to an application (e.g., application 131) interfaced by a user 102 corresponding to a SSN be masked and encrypted. This is just one example.

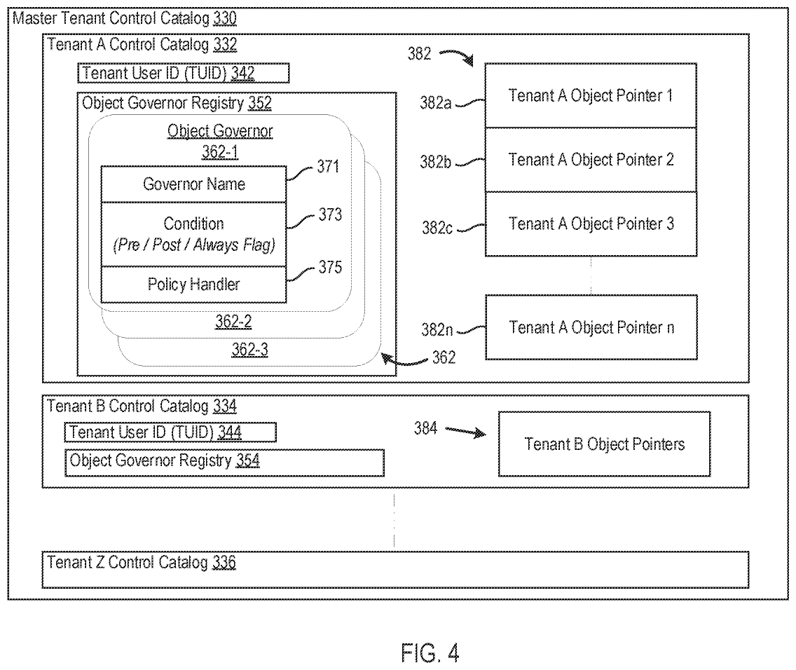

Referring to FIG. 4, aspects of the governance data structures implemented in governance service operations will now be described. The governance data structures include a Master Tenant Control Catalog 330 which includes one or more Tenant Control Catalogs 332, 334, 336.

The Master Tenant Control Catalog 330 is a data structure that contains all the Tenant Control Catalogs for a NoSQL DaaS realm. There is one Master Tenant Control Catalog per realm as shown in the figure below. This may be created when the datastore service is initiated as part of the bootstrap process. The contents of the Master Tenant Control Catalog 330 are populated as tenants are enrolled in the service.

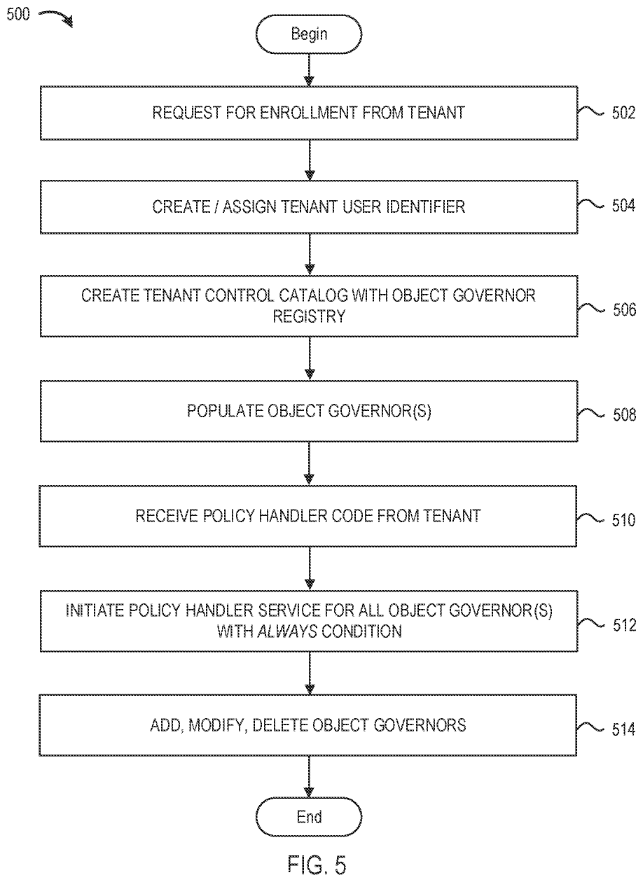

During the enrollment process, described in more detail with reference to FIG. 5, each tenant is assigned a unique identifier (ID) called Tenant User Identifier (TUID) (e.g., TUID 342, 344 depicted in FIG. 4). The TUID is unique within the datastore realm and is used to provide the user context within which the Policy Handler code will be executed. This user context defines the operating boundaries for the Policy Handler and is also used to manage all resources (such as compute, memory, storage, network access, etc.) used by the Policy Handler.

The Tenant Control Catalogs 332, 334, 336 are tenant specific data structures identified by their TUID (e.g., TUID 342, 344 depicted in FIG. 4) and include two items, an Object Governor Registry 352 and 354 and Tenant Object Pointer(s) 382 and 384 (e.g., including pointers 382a-382n and 384 depicted in FIG. 4). For example, each tenant is assigned a tenant specific Object Governor Registry and can only manage (e.g., read, update, and delete) Object Governors within their Object Governor Registry or ones that they have been provided access rights. For purposes of further explanation of the Tenant Control Catalogs 332, 334, 336, reference will be made specifically to Tenant A Control Catalog 332, however, it should be understood that each enrolled tenant would include a tenant specific control catalog. In other words, each tenant managed by the governor service has their own individual Tenant Control Catalog within that realm.

The Object Governor Registry 352 for Tenant A (e.g., identified by TUID 342), includes three Object Governors 362-1, 362-2, and 362-3, collectively referred to herein as Object Governors 362. Though three Object Governors 362 are shown in an example, there may be any number of Object Governors in an Object Governor Registry. A database service may create and manage the data structure referred to herein as the Object Governor Registry 352. The Object Governor Registry 352 stores all the Object Governors 362 for a tenant. Every tenant is assigned their own registry, and can manage (e.g., read, update, or delete) the Object Governors 362 that they have created or those that they have been granted access rights.

The Object Governors 362 include three aspects, a Governor Name 371, a Condition 373, and a Policy Handler 375. The Governor Name 371 is a unique name given to the Object Governor by the tenant. The Condition 373 is a data structure that contains a set of Boolean logic conditions, also referred to as expressions, which evaluates to True or False. If the logic conditions evaluate to True, then the Policy Handler 375 is invoked. If the log conditions evaluate to False, then no action, with respect to the specific Object Governors 362 is taken. The Condition 373 also includes a Pre, Post, or Always flag to indicate whether the Condition is evaluated prior to, or after the transaction (e.g., a CRUD operation) is executed. If the flag is set to Always, then the condition is irrelevant, and the code in the Policy Handler 375 will run persistently (e.g., as a daemon service).

For Conditions 373 that have a flag is set to Pre, the subprocess Pre is performed prior to a CRUD operation. For each Object Governor item in the Object Governor Registry that have the Condition flag set to Pre, the Governor Service, prior to a permitting execution of the CRUD operation on an Object, first evaluates the Boolean logic defined by the Condition 373. If the logic conditions evaluate to False, then no action is taken, and the process proceed to another Object Governor having a condition flag of Pre. However, if the logic conditions evaluate to True, then the executable code identified by the Policy Handler 375 is executed.

For Conditions 373 that have a flag set to Post, the subprocess Post is performed after a CRUD operation. For each Object Governor item in the Object Governor Registry that have the Condition flag set to Post, after the CRUD operation is executed, the Boolean logic defined by the Condition 373 is evaluated. If the logic conditions evaluate to False, then no action is taken, and the process proceeds to another Object Governor having a condition flag of Post. However, if the logic conditions evaluate to True, then the executable code identified by the Policy Handler 375 is executed.

As noted above, the Condition 373 includes a set of Boolean logic conditions that evaluates various aspects of a request to read, update, create, or delete an Object. The various aspects may include an identity of the user, tenant, or application making the request, the timeframe that the request is being made (e.g., outside of normal or expected operating hours), an IP address of the request, a device type making the request, or the like. For example, a set of Boolean logic conditions may include determining that a user is within an authorized list of users, for example, to interact with a specific Object, determining that an application is authorized to interact with the specific Object, determining whether an intended CRUD operation is permitted to be performed on the specific Object, or the like.

The Policy Handler 375 stores a pointer to executable code within a folder specified within the tenant's realm. The Policy Handler field can contain the full path name to a file with executable code, such as a dynamically linked library or object code, a script or binary executable file, which would be executed if the Condition 373 is True or set to Always. The executable code defines one or more tenant developed policies to be executed when the Condition is True. For example, the executable code for a policy may be configured to mask specific elements of an Object, such as SSNs or other personal identifying information from an application or user of an application. As another example, the executable code for a policy may be configured to trigger an additional authentication process such as providing a subpoena reference or a second user before access is granted to an Object. These are only a few examples of policies that may be implemented by the executable code.

The executable code is executed if the related Condition is True. The Policy Handler may return data items such as completion status, error codes, or even throw exceptions. Policy Handlers may also receive variable input data as parameters.

In some embodiments, in order to maintain security with respect to execution of the Policy Handlers, the code may be executed within a secure context. For example, the code may be executed by the Governor Service (e.g., implemented via a computing device having a processor and memory) that is different than the DaaS provider, for example, by an entity that assumes an identity and thereby inheriting all related security privileges assigned to the tenant. As another example, the code may be executed by a different application thread than the Governor Service. As such, this can provide thread and memory safe execution of the code. For example, the code may be executed on a system local to the tenant (e.g., on an on-premises device of the tenant) instead of by services operated by the DaaS provider. This can protect the Governor Service of the DaaS provider from security issues or errors in the code provided by the tenant.

Additionally, Policy Handlers 375 may also receive variable input data including the Object(s) to be stored in the database as parameters as part of the invocation. Upon execution of the code indicated by the Policy Handler, the Policy Handler may modify any Object(s) received during the invocation and/or also return other data items such as a completion status (for e.g., success/failure), error codes, or indicate exceptions.

Still referring to FIG. 4, Tenant A Control Catalog 332 includes Tenant A Object Pointers 382. Tenant A Object Pointers 382 are pointers to the location within the datastore where the tenant's Object(s) reside. The pointers may indicate memory and/or storage addresses (e.g., physical block addresses and/or logical block addresses) where the tenant's Object(s) reside. These pointers are unique within the datastore realm.

With reference to FIG. 5, a tenant enrollment process in the governance service will now be described. FIG. 5 depicts an example process flow 500 for enrolling and establishing Object Governors for a tenant. This process may be executed when each new tenant enrolls for governance service. The DaaS provider or a tertiary governor service may execute the following operations to enroll a tenant.

At step 502, a request for enrollment from a tenant is received. The request may include tenant identifying information and/or specifications for establishing a datastore with the service provider (e.g., either the DaaS provider or the governor service).

At step 504, the service provider creates a tenant user identifier (e.g., TUID 342 as depicted in FIG. 4).

At step 506, the service provider creates a directory where the tenant's Policy Handler code is stored as a file. The directory folder may also store other data related to the tenant such as metadata or configuration files used by the Policy Handler. Each tenant is given their own directory, which may contain subdirectories that can be used by a tenant to organize their policy handlers and store additional information such as executable code, object files, scripts, configuration files, and/or metadata. The database service also creates the Tenant Control Catalog (including Object Governor Registry) for that tenant within the Master Tenant Control Catalog.

At step 508, the service provider enables a tenant to create and populate the fields for all their Object Governor(s) that govern their data. For example, the tenant provides the service provider with names for the Object Governor(s) as well as logic for the Conditions 373 for each of the Object Governor(s).

At step 510, the service provider receives policy handler code and any other related files to store in the tenant's directory and/or sub-directory as needed. Pointers are generated for the Policy Handler in the tenant's Object Governor(s) to indicate where the policy handler code (e.g., the executable code and related files) is stored. Steps 508 and 510 may be repeated a number of times as the tenant builds their desired Object Governor(s).

At step 512, once the tenant enrollment is established, the service provider inspects the Object Governor Registry for the enrolled tenant. If an Object Governor has a Condition set to Always, then the code listed in the Policy Handler is executed as a persistently running service.

Although creating and populating the Object Governors can be done during the enrollment phase, this is not a requirement. At step 514, tenants can add, modify, or delete Object Governors including related code and scripts after enrollment according to governance requirements. As such, a tenant can add and update Object Governors at any time as governance requirements evolve. If an Object Governor is deleted, the tenant is provided an option to physically or logically delete all related policy handlers (including related directories and subdirectories, and other stored information such as executable code, object files, scripts, configuration files, and metadata). When an Object Governor is physically or logically deleted, any executing policy handler code of an Object Governor whether the flagged Condition is Pre, Post, or Always will be terminated in a graceful manner as defined within the logic of the policy handler code.

In some embodiments, the DaaS provider may also provide Object Governors including related code and scripts that govern tenants as part of a packaged catalog of services offered. The DaaS provider may allow tenants to copy and modify the code offered in the Policy Handlers. The DaaS provider may also hide these from the tenant. For example, the code may execute silently within the Management Plane such that the tenant does not need to manage certain aspects of the security and governance that the DaaS provider implements. Furthermore, the DaaS provider may add Object Governors after the enrollment is completed.

The aforementioned enrollment process may be implemented, for example, through a Graphical User Interface (GUI), command line, or API. For example, the tenants can enroll their Object Governors using a GUI, command line, or API. Irrespective of the enrollment method, the tenant user may need to enter all the fields for each Object Governor (e.g., the Name, Condition, and Policy Handler) they want to enroll, or some fields may be auto populated (e.g., Name). The tenant may enroll as many Object Governors as required for their governance requirements.

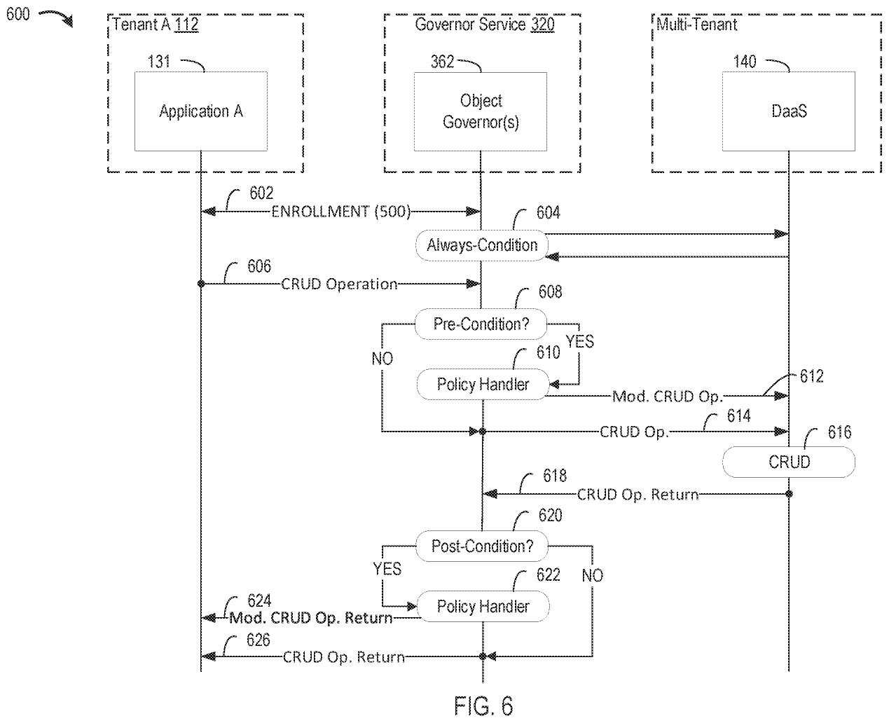

Once the governance service for a tenant is established, tenant application operations are governed by at least the Object Governors defined by the tenant. For example, some Object Governors that govern tenant application operations may include Object Governors that were predefined by a Governor Service and either automatically implemented upon enrollment of a tenant or selectable by a tenant from a library of predefined Object Governors. FIG. 6 depicts an illustrative process flow 600 for performing governance services corresponding to the Object Governors.

At step 602, an enrollment process is performed between the tenant (e.g., Tenant A 112) and a service provider such as a governor service 320 or a DaaS provider. The enrollment process may be the process described with reference to FIG. 5.

At step 604, once enrollment is completed, Object Governors with a Condition flag of Always are started and persistently execute.

At step 606, an application, for example Application A 131 interacted with by Tenant A 112, initiates a CRUD operation for interaction with a tenant's Object stored in the multi-tenant DaaS system 140.

At step 608, the governor service determines whether any Object Governors have a Condition flag set to Pre. If an Object Governor has a Condition flag set to Pre, YES at step 608 and logic of the Condition evaluates to TRUE, then the process proceeds to step 610, where the executable code identified by the Policy Handler of the Object Governor is executed. In some embodiments, the executable code corresponding to a governance policy may modify the CRUD operation at step 612 and permit operation of the CRUD operation to interact with the Object stored in the multi-tenant DaaS system 140.

If there are more than one Object Governor with a Condition flag set to Pre, each of those Object Governors are evaluated. The Object Governors may be evaluated in any order or a predefined order.

If an Object Governor does not have a Condition flag set to Pre, NO at step 608, then the process proceeds to step 614 where the CRUD operation passed to the multi-tenant DaaS system 140. At step 616, the CRUD operation or the modified CRUD operation is performed.

At step 618, a return, which may include an Object, a confirmation of an action, an error status or the like based on the CRUD operation performed at step 616 is passed back to the application. However, before returning to the application, the governor service determines whether any Object Governors have a Condition flag set to Post.

If an Object Governor has a Condition flag set to Post, YES at step 620 and logic of the Condition evaluates to TRUE, then the process proceeds to step 622, where the executable code identified by the Policy Handler of the Object Governor is executed. In some embodiments, the executable code corresponding to a governance policy may modify the return information from the CRUD operation at step 624.

If there are more than one Object Governor with a Condition flag set to Post, each of those Object Governors are evaluated. The Object Governors may be evaluated in any order or a predefined order.

If an Object Governor does not a Condition flag set to Post, NO at step 620, then the process proceeds to step 626 where the return information from the CRUD operation at step 618 is transmitted to the application that executed the CRUD operation.

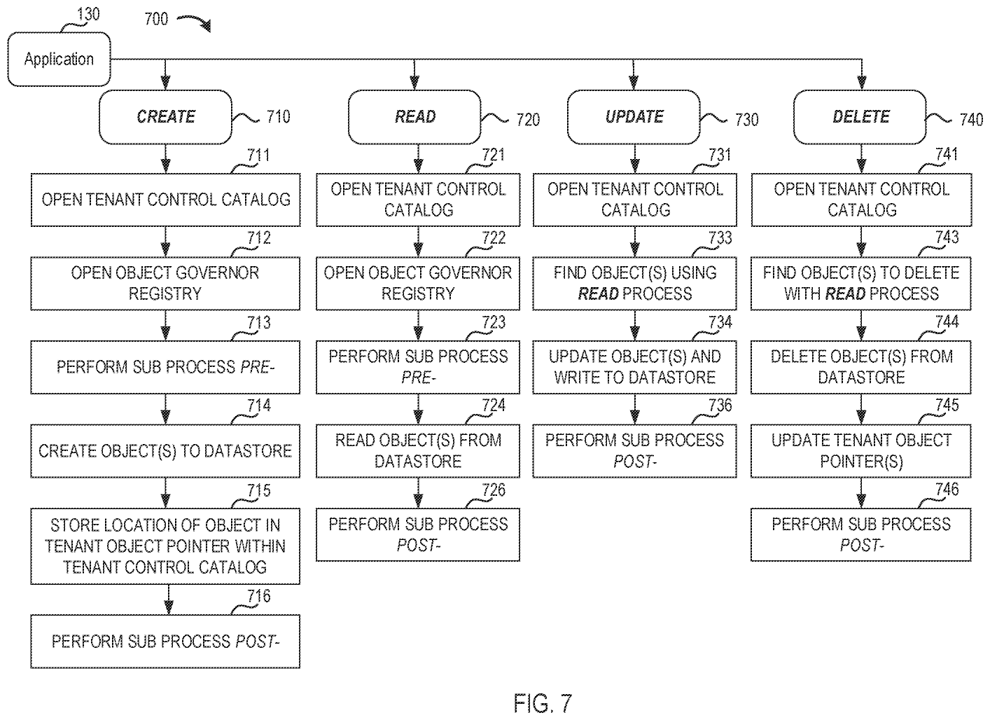

Turning to FIG. 7, a more detailed process flow 700 is depicted. Process flow 700 illustrates operations that may be involved with specific CRUD operations with executed with aspects of the governance services described herein.

For example, when an application 130 executes a create operation 710 the following processes may be performed by the governor service and/or the DaaS provider. At step 711, the tenant control catalog corresponding to the tenant that is operating the application 130 is opened. The tenant may be determined based on an indication of the TUID provided with the create operation 710. Additionally, at step 712, the object governor registry corresponding to the tenant that is operating the application 130 is opened. At step 713, Object Governors having a Condition with a flag set to Pre are performed. At step 714, the Object desired to be created by the create operation 710 is created in the datastore. At step 715, a tenant object pointer (e.g., Tenant Object Pointer 382a as depicted in FIG. 4) identifying the location of the created Object is created and stored within the Tenant Control Catalog. At step 716, Object Governors having a Condition with a flag set to Post are performed.

When an application 130 executes a read operation 720 the following processes may be performed by the governor service and/or the DaaS provider. Steps 721-723 are the same as steps 711-713 for the create operation 710. At step 724, the Object desired to be read by the read operation 720 are obtained and read. The read operation may return information about the Object to the application 130. At step 726, Object Governors having a Condition with a flag set to Post are performed.

When an application 130 executes an update operation 730 the following processes may be performed by the governor service and/or the DaaS provider. Step 731 is the same as step 711 for the create operation 710. At step 733, the update operation 730 searches for and finds the Object for updating using the read operation 720. At step 734, the Object desired to be update by the update operation 730 is updated in the datastore. At step 736, Object Governors having a Condition with a flag set to Post are performed.

When an application 130 executes a delete operation 740 the following processes may be performed by the governor service and/or the DaaS provider. Deletion operations may include a physical deletion a logical deletion. Step 741 is the same as step 711 for the create operation 710. Step 743 is the same as step 733 for the update operation 730. At step 744, the Object desired to be deleted by the delete operation 740 is deleted from the datastore. At step 745, the tenant object pointer (e.g., Tenant Object Pointer 382a as depicted in FIG. 4) identifying the location of the deleted Object is updated in or deleted from the Tenant Control Catalog. At step 746 Object Governors having a Condition with a flag set to Post are performed.

It should be understood that the CRUD operations described herein with respect to the implementation with the governance services is one example and that additional or alternative steps may be incorporated.

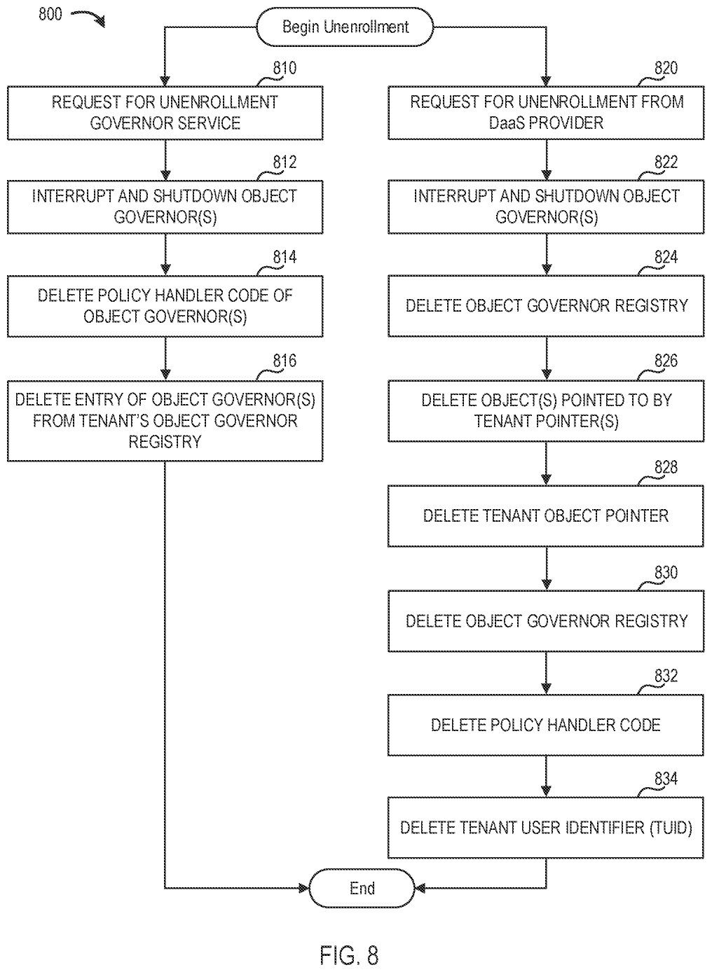

FIG. 8 depicts a process flow 800 for a tenant to unenroll from the governance service and/or the DaaS. In an embodiment where a tenant desires to unenroll from the governance service, the governor service receives a request for enrollment from the tenant at step 810. In response to the request to unenroll, at step 812, the governor service identifies and shuts down any executing policy handler code of an Object Governor whether the flagged Condition is Pre, Post, or Always in a graceful manner as defined within the logic of the policy handle code. As used herein, reference to stopping processes in a “graceful manner” describes a shutdown process that terminates processes associated with the Object Governor that minimizes the adverse impacts to the system and data. For example, the shutdown process includes an ordered process of releasing system resources such as memory and disk space, closing network connections, logging status messages, closing files, and completing transactions in progress.

Next, at step 814, code corresponding to the Policy Handlers for each of the Object Governor(s) of the tenant requesting enrollment is deleted. Last, at step 816, entry(ies) of the Object Governor(s) are deleted from the tenant's Object Governor Registry.

In an embodiment where a tenant desires to unenroll from the DaaS, the DaaS provider receives a request for unenrollment from the tenant at step 820. In response to the request to unenroll, at step 822, the DaaS provider identifies, interrupts, and shuts down Object Governor(s) that have a Condition with a flag set to Always. Next, at step 824, entry(ies) of the Object Governor(s) are deleted from the tenant's Object Governor Registry. Then, the DaaS provider proceeds to delete Objects pointed to by the tenant's Object Pointers at step 826, delete the tenant's Object Pointers at step 828, delete the tenant's Object Governor Registry at step 830, and delete the code corresponding to the Policy Handlers for each of the Object Governor(s) of the tenant requesting unenrollment at 832. Last, at step 834, the DaaS provider deletes the TUID.

When a tenant unsubscribes or unenrolls from the DaaS service, their data will be removed from datastore. Tenants may work with the DaaS provider to perform a backup of their data prior to data deletion.

The unenrollment processes can be done at any time by a tenant using a Graphical User Interface (GUI), command line or API.

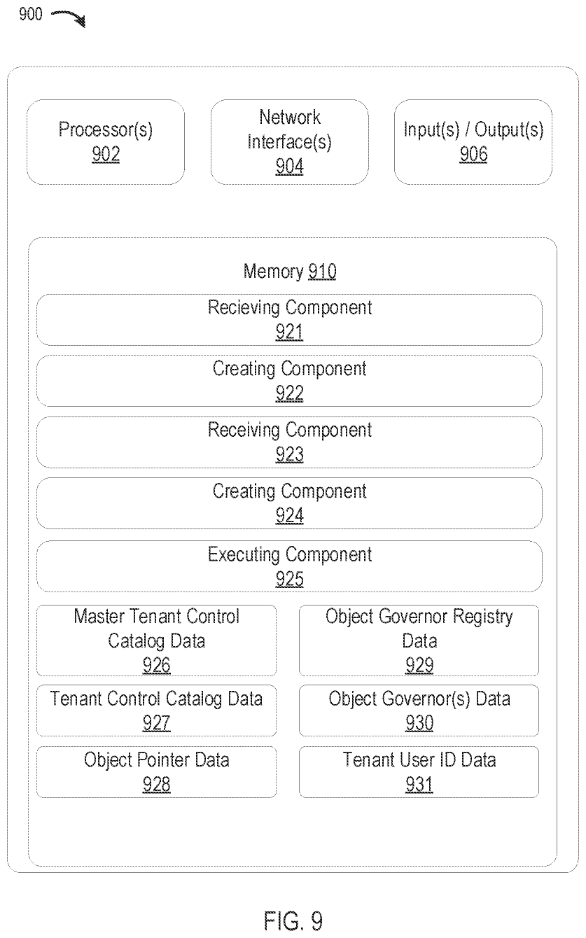

FIG. 9 depicts an example processing system configured to perform the methods described herein. For example, the processing system may be a tenant based system, a SaaS system, a governor service system, a DaaS system or a combination thereof.

Processing system 900 includes one or more processors 902. Generally, processor(s) 902 may be configured to execute computer-executable instructions (e.g., software code) to perform various functions, as described herein.

Processing system 900 further includes a network interface(s) 904, which generally provides data access to any sort of data network, including personal area networks (PANs), local area networks (LANs), wide area networks (WANs), the Internet, and the like.

Processing system 900 further includes input(s) and output(s) 906, which generally provide means for providing data to and from processing system 900, such as via connection to computing device peripherals, including user interface peripherals. For example, the input(s) and output(s) may include a monitor, keyboard, mouse, printer, camera, microphone, speaker, and/or other device for receiving, sending, and/or presenting data.

Processing system further includes a memory 910 configured to store various types of components and data. The memory 910 may be machine-readable memory, which may also be referred to as a non-transitory processor readable memory. The memory 910 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components.

In this example, memory 910 includes a receiving component 921, a creating component 922, a receiving component 923, a creating component 924, and an executing component 924. The receiving component 921 includes a set of instructions that when executed perform the operations, for example, of step 502 of the enrollment process 500 described herein with reference to FIG. 5.

The creating component 922 includes a set of instructions that when executed perform the operations, for example, of steps 504-506 of the enrollment process 500 described herein with reference to FIG. 5.

The receiving component 923 includes a set of instructions that when executed perform the operations, for example, of steps 508-510 of the enrollment process 500 described herein with reference to FIG. 5.

The receiving component 924 includes a set of instructions that when executed perform the operations, for example, of steps 506-508 of the enrollment process 500 described herein with reference to FIG. 5.

The receiving component 925 includes a set of instructions that when executed perform the operations, for example, of step 512 of the enrollment process 500 described herein with reference to FIG. 5.

In this example, memory 910 further includes master tenant control catalog data 926 corresponding to the master tenant control catalog 330 depicted and described with reference to FIG. 4, tenant control catalog data 927 corresponding to the tenant control catalog 332 depicted and described with reference to FIG. 4, object pointer data 928 corresponding to the tenant object pointers 382 depicted and described with reference to FIG. 4, object governor registry data 929 corresponding to the object governor registry 352 depicted and described with reference to FIG. 4, object governor data 930 corresponding to the object governors 362 depicted and described with reference to FIG. 4, and tenant user identifier data 931 corresponding to the TUID 342 depicted and described with reference to FIG. 4.

Processing system 900 may be implemented in various ways. For example, processing system 900 may be implemented within on-site, remote, or cloud-based processing equipment.

Processing system 900 is just one example, and other configurations are possible. For example, in alternative embodiments, aspects described with respect to processing system 900 may be omitted, added, or substituted for alternative aspects.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more non-transitory computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for implementing custom tenant governance controls for objects stored in a datastore, comprising:
receiving a request from a tenant for enrollment in a governance service with a service provider;
creating a tenant control catalog with an object governor registry based on the request for enrollment;
receiving, from the tenant, a specification for one or more object governors, wherein the specification comprises at least a name, a condition indicating when to implement one of the one or more object governors, and code of a policy handler that is executed when the one of the one or more object governors is implemented based on satisfaction of the condition;
creating the one or more object governors within the object governor registry based on the specification; and
causing the code of the policy handler to be executed when the condition of at least one of the one or more object governors is satisfied.

2. The method of claim 1, further comprising receiving an operation to perform on the datastore, wherein the condition of the least one of the one or more object governors has a flag indicating the condition is a pre-condition, and wherein causing the code of the policy handler to be executed comprises causing the code of the policy handler to be executed before the received operation is performed.

3. The method of claim 1, further comprising receiving an operation to perform on the datastore, wherein the condition of the least one of the one or more object governors has a flag indicating the condition is a post-condition, and wherein causing the code of the policy handler to be executed comprises causing the code of the policy handler to be executed after the received operation is performed.

4. The method of claim 1, further comprising creating a tenant object pointer in the tenant control catalog for each object associated with the tenant that is stored in the datastore.

5. The method of claim 1, further comprising creating a unique tenant user identifier for the tenant based on the request for enrollment.

6. The method of claim 1, wherein the condition comprises logic, which when the logic is evaluated to TRUE, causes the code of the policy handler to be executed.

7. The method of claim 1, wherein the code of the policy handler defines a governance policy to be implemented for an object stored in the datastore.

8. An apparatus configured for implementing custom tenant governance controls for objects stored in a datastore, comprising: one or more memories comprising processor-executable instructions; and one or more processors configured to execute the processor-executable instructions and cause the apparatus to:
receive a request from a tenant for enrollment in a governance service with a service provider;
create a tenant control catalog with an object governor registry based on the request for enrollment;
receive, from the tenant, a specification for one or more object governors, wherein the specification comprises at least a name, a condition indicating when to implement one of the one or more object governors, and code of a policy handler that is executed when the one of the one or more object governors is implemented based on satisfaction of the condition;
create the one or more object governors within the object governor registry based on the specification; and
cause the code of the policy handler to be executed when the condition of at least one of the one or more object governors is satisfied.

9. The apparatus of claim 8, wherein the one or more processors are configured to execute the processor-executable instructions and cause the apparatus to receive an operation to perform on the datastore, wherein the condition of the least one of the one or more object governors has a flag indicating the condition is a pre-condition, and wherein causing the code of the policy handler to be executed comprises causing the code of the policy handler to be executed before the received operation is performed.

10. The apparatus of claim 8, wherein the one or more processors are configured to execute the processor-executable instructions and cause the apparatus to receive an operation to perform on the datastore, wherein the condition of the least one of the one or more object governors has a flag indicating the condition is a post-condition, and wherein to cause the code of the policy handler to be executed comprises causing the code of the policy handler to be executed after the received operation is performed.

11. The apparatus of claim 8, wherein the one or more processors are configured to execute the processor-executable instructions and cause the apparatus to create a tenant object pointer in the tenant control catalog for each object associated with the tenant that is stored in the datastore.

12. The apparatus of claim 8, wherein the one or more processors are configured to execute the processor-executable instructions and cause the apparatus to create a unique tenant user identifier for the tenant based on the request for enrollment.

13. The apparatus of claim 8, wherein the condition comprises logic, which when the logic is evaluated to TRUE, causes the code of the policy handler to be executed.

14. The apparatus of claim 8, wherein the code of the policy handler defines a governance policy to be implemented for an object stored in the datastore.

15. A non-transitory computer-readable medium comprising instructions that, when executed by one or more processors of a computing system, cause the computing system to perform operations for implementing custom tenant governance controls for objects stored in a datastore, the operations comprising:
receiving a request from a tenant for enrollment in a governance service with a service provider;
creating a tenant control catalog with an object governor registry based on the request for enrollment;
receiving, from the tenant, a specification for one or more object governors, wherein the specification comprises at least a name, a condition indicating when to implement one of the one or more object governors, and code of a policy handler that is executed when the one of the one or more object governors is implemented based on satisfaction of the condition;
creating the one or more object governors within the object governor registry based on the specification; and
causing the code of the policy handler to be executed when the condition of at least one of the one or more object governors is satisfied.

16. The non-transitory computer-readable medium of claim 15, further comprising instructions, that when executed by the one or more processors of the computing system, cause the computing system to receive an operation to perform on the datastore, wherein the condition of the least one of the one or more object governors has a flag indicating the condition is a pre-condition, and wherein causing the code of the policy handler to be executed comprises causing the code of the policy handler to be executed before the received operation is performed.

17. The non-transitory computer-readable medium of claim 15, further comprising instructions, that when executed by the one or more processors of the computing system, cause the computing system to receive an operation to perform on the datastore, wherein the condition of the least one of the one or more object governors has a flag indicating the condition is a post-condition, and wherein causing the code of the policy handler to be executed comprises causing the code of the policy handler to be executed after the received operation is performed.

18. The non-transitory computer-readable medium of claim 15, further comprising instructions, that when executed by the one or more processors of the computing system, cause the computing system to create a tenant object pointer in the tenant control catalog for each object associated with the tenant that is stored in the datastore.

19. The non-transitory computer-readable medium of claim 15, further comprising instructions, that when executed by the one or more processors of the computing system, cause the computing system to create a unique tenant user identifier for the tenant based on the request for enrollment.

20. The non-transitory computer-readable medium of claim 15, wherein the condition comprises logic, which when the logic is evaluated to TRUE, causes the code of the policy handler to be executed.
